(19) United States
(12) Patent Application Publication
(10) Pub. No.: US 2019/0270669 A1
(43) Pub. Date: Sep. 5, 2019

(54) METHODS AND APPARATUS FOR POSITIONING AND SECURING GLASS, GLASS-CERAMIC AND CERAMIC SUBSTRATES FOR COATING

(71) Applicant: CORNING INCORPORATED, CORNING, NY (US)

(72) Inventors: Daniel Robert Boughton, Naples, NY (US); James Gerard Fagan, Painted Post, NY (US); Valerie Elise Mebert, Corning, NY (US); Kenneth Spencer Morgan, Painted Post, NY (US)

(21) Appl. No.: 16/344,982

(22) PCT Filed: Oct. 24, 2017
(86) PCT No.: PCT/US17/57991

§ 371 Date: Apr. 25, 2019

Related U.S. Application Data
(60) Provisional application No. 62/412,397, filed on Oct. 25, 2016.

(51) Int. Cl. C03C 17/00; C04B 41/87; C04B 41/89

(52) U.S. Cl. CPC C03C 17/007; C04B 41/89; C04B 41/87

(57) ABSTRACT

A method of preparing a glass, glass-ceramic or ceramic substrate for coating that includes: treating a primary surface of a carrier to form a carrier bonding surface, the carrier having a thickness of at least 2 mm; disposing a carrier surface modification layer on the carrier bonding surface; bonding the carrier to at least one substrate having a substrate bonding surface and a thickness from about 0.1 mm to about 3.5 mm, the bonding conducted by temporarily joining the carrier at the carrier surface modification layer to the substrate at the substrate bonding surface. Further, the treating and disposing steps are conducted such that an adhesion energy between the carrier surface modification layer and the substrate bonding surface is from 50 to 1000 mJ/m² after the bonding step.

### CROSS-REFERENCE TO RELATED APPLICATIONS

This application claims the benefit of priority under 35 U.S.C. § 119 of U.S. Provisional Application Ser. No. 62/412397 filed on Oct. 25, 2016, the content of which is relied upon and incorporated herein by reference in its entirety.

### BACKGROUND

The present disclosure relates generally to methods and apparatus for positioning and securing substrates for coating and, more particularly, for methods and apparatus for coating cover glass substrates with scratch-resistant coatings.

Glass elements have been used as cover glass substrates for various electronic devices for years. Various technologies have been recently developed to place functional coatings on these substrates with particular features and properties. These functional coatings include antimicrobial coatings, scratch-resistant coatings, fingerprint-resistant coatings, and antireflection coatings.

As these coating technologies have evolved to provide desired properties and attributes on the surface of cover glass substrates, challenges remain in incorporating them into the products containing these substrates at low manufacturing cost and high manufacturing volumes. Positioning and securing glass substrates in various coating apparatus is technically difficult. For example, the substrates can be prone to damage from handling and direct fixture contact. Further, certain coating processes can place large mechanical forces on the parts giving rise to significant contact forces between the parts and the fixtures employed in the process.

In many conventional approaches, the non-user-facing side of the cover glass substrate is attached to a fixture during coating with an adhesive or an adhesive tape. Additional manufacturing steps are usually necessary to remove the adhesive between a fixture and the glass substrate. It is also common for the adhesive to leave a residue on the substrate after the substrate is removed from the fixture, requiring an additional cleaning step. These additional manufacturing steps, e.g., adhesive cleaning and removal, can result in additional manufacturing time and increased handling of the substrates, both of which can lead to increased manufacturing cost and decreased yield.

Accordingly, there is a need for methods and apparatus for positioning and securing substrates for coating with high reliability, low manufacturing cost and high manufacturing flexibility.

### SUMMARY

According to a first embodiment, there is provided a method of preparing an article for coating, comprising:

treating a primary surface of a carrier to form a carrier bonding surface;

disposing a carrier surface modification layer on the carrier bonding surface;

bonding the carrier to a plurality of substrates, each substrate comprising a substrate bonding surface, the bonding conducted by temporarily joining the carrier at the carrier surface modification layer to each of the substrates at each of their respective substrate bonding surfaces,

wherein the treating and disposing steps are conducted such that an adhesion energy between the carrier surface modification layer and each of the substrate bonding surfaces is from 50 to 1000 mJ/m2 after the bonding step.

According to a second embodiment, there is provided the method according to embodiment 1, the carrier comprising a thickness of at least 2 mm, and each of the plurality of substrates comprising a thickness from about 0.1 mm to about 3.5 mm.

According to a third embodiment, there is provided the method according to embodiment 1 or embodiment 2, wherein the adhesion energy is from 50 to 1000 mJ/m2 after a coating is disposed on the at least one substrate at a coating temperature of 300° C. or less and a coating pressure from 10-6 Torr to 760 Torr.

According to a fourth embodiment, there is provided the method according to any one of embodiments 1-3, wherein the surface area of the carrier surface modification layer is about 60% of the surface area of the substrate bonding surfaces, and the adhesion energy is from 180 to 1000 mJ/m2 after the bonding step.

According to a fifth embodiment, there is provided the method according to embodiment 3, wherein at least one of the plurality of substrates is a strengthened substrate suitable for display glass applications.

According to a sixth embodiment, there is provided the method according to embodiment 4, wherein the coating is a scratch-resistant layer deposited on at least one primary surface of at least one of the plurality of substrates with a physical vapor deposition or plasma-enhanced vapor deposition process.

According to a seventh embodiment, there is provided the method according to embodiment 3, wherein the coating is disposed on at least one of the plurality of substrates with a drum coating process that subjects the at least one substrate to a centrifugal force from about 1 N to 20 N.

According to an eighth embodiment, there is provided the method according to embodiment 3, wherein the treating step comprises cleaning the primary surface of the carrier with a cleaning composition comprising deionized water and hydrogen peroxide at a temperature from ambient temperature to 70° C.

According to a ninth embodiment, there is provided the method according to embodiment 3, wherein the carrier surface modification layer comprises a hydrocarbon-based material.

According to a tenth embodiment, there is provided the method according to embodiment 3, further comprising the step:

de-bonding the carrier from at least one of the plurality of substrates after the coating is disposed on the at least one of the plurality of substrates, the de-bonding conducted by mechanically separating the carrier surface modification layer from the substrate bonding surface of the at least one of the plurality of substrates without breakage to the carrier and the at least one of the plurality of substrates.

According to an eleventh embodiment, there is provided the method according to embodiment 10, wherein the substrate bonding surface of the at least one of the plurality of substrates comprises no more than trace amounts of the carrier surface modification layer after the de-bonding step.

According to a twelfth embodiment, there is provided the method according to any one of embodiments 1-11, wherein at least one of the plurality of substrates is substantially non-planar in shape.

According to a thirteenth embodiment, there is provided the method according to any one of embodiments 1-12, wherein at least one of the plurality of substrates is substantially non-planar in shape and the substrate bonding surface of the at least one of the plurality of substrates is located on a substantially planar portion of the at least one substrate.

According to a fourteenth embodiment, there is provided the method according to any one of embodiments 1-13, wherein the carrier surface modification layer has a smaller surface area than the primary surface of the carrier.

According to a fifteenth embodiment, there is provided the method according to any one of embodiments 1-14, wherein the surface modification layer has a smaller surface area than the substrate bonding surface of at least one of the plurality of substrates.

According to a sixteenth embodiment, there is provided an article for coating, comprising:

a carrier comprising a carrier bonding surface;

a carrier surface modification layer disposed on the carrier bonding surface; and

a plurality of substrates, each of the plurality of substrates comprising a substrate bonding surface,

wherein the carrier surface modification layer and the substrate bonding surface are joined such that such that an adhesion energy from 50 to 1000 mJ/m2 exists between the carrier surface modification layer and the substrate bonding surface of at least one of the substrates, and

further wherein the carrier is mechanically removable from the at least one of the substrates without breakage to the at least one of the substrates and the carrier.

According to a seventeenth embodiment, there is provided the article according to embodiment 16, the carrier comprising a thickness of at least 2 mm, the at least one of the plurality of substrates comprising a thickness from about 0.1 mm to about 3.5 mm.

According to an eighteenth embodiment, there is provided the article according to embodiment 16 or embodiment 17, wherein the adhesion energy is from 50 to 1000 mJ/m2 after a coating is disposed on the at least one substrate at a coating temperature of 300° C. or less and a coating pressure from 10-6 Torr to 760 Torr.

According to a nineteenth embodiment, there is provided the article according to any one of embodiments 16-18, wherein the surface area of the carrier surface modification layer is about 60% of the surface area of the substrate bonding surfaces, and the adhesion energy is from 180 to 1000 mJ/m2 after a coating is disposed on the at least one substrate at a coating temperature of 300° C. or less and a coating pressure from 10-6 Torr to 760 Torr.

According to a twentieth embodiment, there is provided the article according to any one of embodiments 16-19, wherein the carrier surface modification layer comprises a hydrocarbon-based material.

According to a twenty first embodiment, there is provided the article according to any one of embodiments 16-20, wherein the carrier is mechanically removable from the at least one substrate such that the substrate bonding surface of the at least one substrate comprises no more than trace amounts of the carrier surface modification layer.

According to a twenty second embodiment, there is provided a fixture assembly for coating a substrate, comprising

at least one carrier comprising a carrier bonding surface, and a mounting surface;

a carrier surface modification layer disposed on the carrier bonding surface; and

a cam assembly comprising at least one clamp that is removably coupled to the mounting surface of the at least one carrier, and a plate removably coupled to the at least one clamp,

wherein the carrier surface modification layer temporarily couples to a substrate bonding surface of a substrate with an adhesion energy from 50 to 1000 mJ/m2.

According to a twenty third embodiment, there is provided the fixture assembly according to embodiment 22, wherein the at least one carrier and the at least one clamp are a plurality of corresponding carriers and clamps, and further wherein the carrier surface modification layer of each carrier temporarily couples to a substrate bonding surface of a substrate with an adhesion energy from 50 to 1000 mJ/m2.

According to a twenty fourth embodiment, there is provided the fixture assembly according to embodiment 22, wherein the carrier surface modification layer temporarily couples to a substrate bonding surface of a substrate with an adhesion energy from 50 to 1000 mJ/m2 after the coupling and the deposition.

According to a twenty fifth embodiment, there is provided the fixture assembly according to any one of embodiments 22-24, wherein the fixture is adapted for coating a plurality of substrates in a drum coating process that subjects each substrate to a centrifugal force from about 1 N to 20 N.

According to a twenty sixth embodiment, there is provided the fixture assembly according to any one of embodiments 22-25, wherein the carrier surface modification layer temporarily couples with a substrate bonding surface of a substrate that is substantially non-planar in shape such that an adhesion energy from 50 to 1000 mJ/m2 exists between the carrier surface modification layer and the substrate bonding surface.

According to a twenty seventh embodiment, there is provided the fixture assembly according to any one of embodiments 22-26, the at least one carrier comprising a thickness of at least 2 mm.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure as it is claimed.

The accompanying drawings are included to provide a further understanding of principles of the disclosure, and are incorporated in and constitute a part of this specification. The drawings illustrate one or more embodiment(s), and together with the description serve to explain, by way of example, principles and operation of the disclosure. It is to be understood that various features of the disclosure disclosed in this specification and in the drawings can be used in any and all combinations.

### BRIEF DESCRIPTION OF THE DRAWINGS

FIG. 1 is a schematic, plan view of an article for coating that includes a carrier, a plurality of substrates, and a carrier surface modification layer and bonding surface disposed between the substrates and the carrier according to some embodiments.

FIG. 1A is a schematic, cross-sectional view of the article for coating depicted in FIG. 1 along line IA-IA.

FIG. 2 is a schematic, plan view of an article for coating that includes a carrier, a substrate, and a carrier surface modification layer and bonding surface disposed between the substrate and the carrier according to some embodiments.

FIG. 2A is a schematic, cross-sectional view of the article for coating depicted in FIG. 2 along line IIA-IIA.

FIG. 3 is a schematic, plan view of an article for coating that includes a carrier, a substrate larger than the carrier, and a carrier surface modification layer and bonding surface disposed between the substrate and the carrier according to some embodiments.

FIG. 3A is a schematic, cross-sectional view of the article for coating depicted in FIG. 3 along line IIIA-IIIA.

FIG. 4 is a schematic, plan view of an article for coating that includes a carrier, a substrate having a substantially non-planar shape, and a carrier surface modification layer and bonding surface disposed between the substrate and the carrier according to some embodiments.

FIG. 4A is a schematic, cross-sectional view of the article for coating depicted in FIG. 4 along line IVA-IVA.

FIGS. 5A, 5B and 5C are schematic views of a fixture assembly for coating a substrate according to some embodiments.

FIGS. 6A and 6B are schematic views of a fixture assembly for coating a plurality of substrates according to some embodiments.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

As used herein, the singular forms “a,” “an” and “the” include plural referents unless the context clearly dictates otherwise. Thus, for example, reference to a “component” includes embodiments having two or more such components, unless the context clearly indicates otherwise.

In general, the energy of adhesion (i.e., “bond energy” or “adhesion energy” as used herein) between two surfaces is measured by a double cantilever beam method or wedge test. The tests simulate in a qualitative manner the forces and effects on an adhesive bond joint at interface between two surfaces. Wedge tests are commonly used for measuring bonding energy. For example, ASTM D5041, Standard Test Method for Fracture Strength in Cleavage of Adhesives in Bonded Joints, and ASTM D3762, Standard Test Method for Adhesive-Bonded Surface Durability of Aluminum, are standard test methods for measuring bonding of substrates with a wedge.

The test method for determining adhesion energies as disclosed herein, which test method is based on but not identical to the above-noted ASTM methods, is as follows. The first sheet is gently pre-cracked or separated at a corner of the glass article locally to break the bond between the first surface and the second surface. A razor blade is used to pre-crack the first surface from the second surface, for example, a GEM brand razor with a thickness of 228±20 microns. In forming the pre-crack, momentary sustained pressure may be needed to fatigue the bond. A flat razor having the aluminum tab removed is slowly inserted until the crack front can be observed to propagate such that the crack separation increases. The flat razor does not need to be inserted significantly to induce a crack. Once a crack is formed, the glass article is permitted to rest for at least 5 minutes to allow the crack to stabilize. Longer rest times may be needed for high humidity environments, for example, above 50% relative humidity.

The glass article with the developed crack is evaluated with a microscope to record the crack length. The crack length is measured from the end separation point of the first surface from the second surface (i.e. furthest separation point from the tip of razor) and the closest non-tapered portion of the razor. The crack length is recorded and used in the following equation to calculate adhesion energy.

γ=3ₜ_{_{b}}²E₁t_{w1}³E₂t_{w2}³/16L⁴(E₁t_{w1}³+E₂t_{w2}³) (1)

wherein γ is the adhesion energy, t_{b} is the thickness of the blade, razor or wedge, E₁ is the Young's modulus of the sheet having the first surface (e.g., a glass carrier), t_{w1} is the thickness of the sheet having the first surface, E₂ is the Young's modulus of the sheet having the second surface (e.g., a thin glass sheet), t_{w2} is the thickness of the sheet having the second surface and L is the crack length between the first surface and second surface upon insertion of the razor blade as described above. The Young's modulus of thin glass sheets as disclosed herein was measured by Resonant Ultrasound Spectroscopy.

The adhesion energy is understood to behave as in silicon wafer bonding, where an initially hydrogen bonded pair of wafers are heated to convert much or all the silanol-silanol hydrogen bonds to Si—O—Si covalent bonds. While the initial, room temperature, hydrogen bonding produces bond energies of the order of about 100-200 mJ/m² which allows separation of the bonded surfaces, a fully covalently bonded wafer pair as achieved during processing at elevated temperatures (on the order of 400 to 800° C.) has adhesion energy of about 2000-3000 mJ/m² which does not allow separation of the bonded surfaces; instead, the two wafers act as a monolith. On the other hand, if both the surfaces are perfectly coated with a low surface energy material, for example a fluoropolymer, with thickness large enough to shield the effect of the underlying substrate, the adhesion energy would be that of the coating material, and would be very low leading to low or no adhesion between the bonding surfaces. Accordingly, the sheet with the second surface would not be able to be processed on the sheet with the first surface. Consider two extreme cases: (a) two standard clean 1 (SC1, as known in the art) cleaned glass surfaces saturated with silanol groups bonded together at room temperature via hydrogen bonding (whereby the adhesion energy is about 100-200 mJ/m²) followed by heating to a temperature that converts the silanol groups to covalent Si-O-Si bonds (whereby the adhesion energy becomes 2000-3000 mJ/m²). This latter adhesion energy is too high for the pair of surfaces to be detachable; and (b) two surfaces perfectly coated with a fluoropolymer with low surface adhesion energy (about 12-20 mJ/m² per surface) bonded at room temperature and heated at a desired processing temperature. In this latter case (b), not only do the surfaces not bond at low temperature (because the total adhesion energy of about 24-40 mJ/m², when the surfaces are put together, is too low), they do not bond at high temperature either as there are too few polar reacting groups. Between these two extremes, a range of adhesion energies exist, for example between 50-1000 mJ/m², which can produce the desired degree of temporary bonding. Accordingly, the inventors have found various methods of providing a modification layer leading to an adhesion energy that is between these two extremes, and such that there can be produced temporary bonding. As used herein “temporary bonding” or “temporarily bonding” means bonding sufficient to maintain a pair of surfaces (for example substrate bonding surface 24a and the upper primary surface of the carrier 10) bonded to one another through processing but also of a degree that (even after processing at desired temperature, for example a temperature of about 300° C., allows the detachment of the first surface from the second surface after processing is complete. Moreover, the detachment of the first surface from the second surface can be performed by mechanical forces, and in such a manner that there is no significant damage to at least the sheet having the second surface, and preferably also so that there is no significant damage to the sheet having the first surface.

Embodiments of the disclosure generally pertain to methods and apparatus for positioning and securing articles containing substrates and carriers for coating. The disclosure also pertains to methods and apparatus for coating cover glass substrates (e.g., Gen 4.5 through Gen 10 size display glass substrates, for example, about 730 mm×920 mm through about 3000 mm×3000 mm) with scratch-resistant coatings (e.g., a layer comprising a silane, alumina, silicon nitride, aluminum nitride, aluminum oxynitride) and other functional coatings. Further, these methods and apparatus for positioning and securing substrates for coating advantageously do so with high reliability, low manufacturing cost and high manufacturing flexibility.

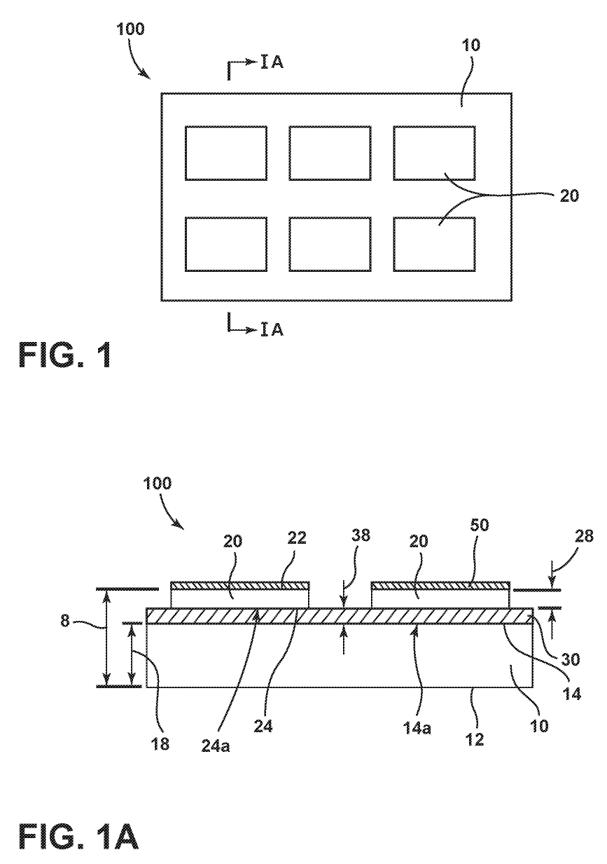

Referring to FIGS. 1 and 1A, an article for coating 100 is depicted that includes a carrier 10 having an upper primary surface 14, lower primary surface 12 and a thickness 18. The carrier 10 further includes a carrier bonding surface 14a. As shown, the article for coating 100 further includes a carrier surface modification layer 30 with a thickness 38 disposed on the carrier bonding surface 14a; and a plurality of substrates 20, each having a thickness 28, substrate bonding surface 24a, lower primary surface 24 and an upper primary surface 22. In addition, a coating 50 is disposed on the upper primary surface 22 of each of the substrates 20. Collectively, the carrier 10, carrier surface modification layer 30 and the substrates 20 have a stack thickness 8.

Turning again to the article for coating 100 depicted in FIGS. 1 and 1A, the carrier surface modification layer 30 and the substrate bonding surface 24a of each of the substrates 20 is joined such that an adhesion energy from 50 to 1000 mJ/m² exists between the carrier surface modification layer 30 and the substrate bonding surface 24a. Within this adhesion energy range, the substrates 20 are effectively in a temporary bond with the carrier 10. The carrier 10 is held to the substrates 20 at these adhesion energies during and after the coating 50 is applied to the substrates 20. In certain embodiments, the carrier 10 is held to the substrates 20 at these adhesion energies after a coating 50 is disposed on the upper primary surface 22 of the substrates 20 at a coating temperature of 300° C. or less at a coating pressure from 10⁻⁶ Torr to 760 Torr (e.g., with a physical vapor or plasma-enhanced vapor deposition process). Further, the coating 50 can be a scratch-resistant layer or layers (e.g., layer or layers comprising a silane, alumina, silicon nitride, aluminum nitride, aluminum oxynitride) or another functional coating (e.g., a fingerprint-resistant coating, anti-reflective coating, anti-microbial coating).

Accordingly, the carrier 10 is mechanically removable from the substrates 20 (or vice versa) such that the risk of breakage of the substrates 20 is eliminated or otherwise significantly reduced, upon completion of the processing steps to develop the coating 50 on the substrates 20. In certain embodiments, the carrier 10 is mechanically removable from the substrates 20 (or vice versa) such that the substrate bonding surface 24a has no more than trace amounts of the carrier surface modification layer 30 on it upon removal of the carrier 10. In certain implementations of the article for coating 100, for example, the adhesion energy that exists between the carrier surface modification layer 30 and the substrate bonding surface 24a can be 50 mJ/m², 100 mJ/m², 150 mJ/m², 200 mJ/m², 250 mJ/m², 300 mJ/m², 350 mJ/m², 400 mJ/m², 450 mJ/m², 500 mJ/m², 550 mJ/m², 600 mJ/m², 650 mJ/m², 700 mJ/m², 750 mJ/m², 800 mJ/m², 850 mJ/m², 900 mJ/m², 950 mJ/m², 1000 mJ/m², and all adhesion energy values between these levels.

In certain embodiments of the article for coating 100, the carrier 10 has a thickness 18 of at least 2 mm. While there is no upper limit to the thickness 18 based on the concepts of this disclosure, practical upper limits for the thickness 18 can be based on a desire to minimize the cost of the carrier 10, size limitations of the apparatus employed to coat the substrates 20 temporarily bonded to the carrier 10, an understanding that strength of glass materials can decrease as a function of increasing size, and other factors. In many implementations, the upper limit of the thickness 18 of the carrier 10 is approximately 51 mm (i.e., about 2 inches). Further the size of the carrier 10 can accommodate one or more substrates 20 of a Gen 1 size or larger, for example, Gen 2 through Gen 10 (e.g., sheet sizes from 100 mm×100 mm to 3 m×3 m or greater).

Referring again to FIGS. 1 and 1A, embodiments of the article for coating 100 include a plurality of substrates 20, each having a thickness 28 from about 0.1 mm to about 3.5 mm. For example, the thickness 28 of the substrates 20 can be 0.1 mm, 0.2 mm, 0.3 mm, 0.4 mm, 0.5 mm, 0.6 mm, 0.7 mm, 0.8 mm, 0.9 mm, 1 mm, 1.5 mm, 2 mm, 2.5 mm, 3 mm, 3.5 mm, and all values between the foregoing thicknesses. Certain embodiments of the substrates 20 have a thickness 28 that ranges from about 0.1 mm to about 1 mm. In general, as the thickness 28 of the substrates 20 increases, the weight of the substrates 20 increases. In certain embodiments, an increased, lower bound for the adhesion energy (e.g., >150 mJ/m²) between the carrier surface modification layer 30 and the substrate bonding surface 24a may be desirable for substrates 20 with larger thicknesses 28, particularly for substrates 20 with thicknesses 28 that exceed 2 mm. In particular, an increased, lower bound for the adhesion energy can ensure that the substrates 20 do not fall from the carrier 10 or otherwise move in an uncontrolled fashion with respect to the carrier 10 during application of the coating 50 to the substrates 20.

Referring again to the article for coating 100 depicted in FIGS. 1 and 1A, the carrier 10, carrier surface modification layer 30 and the substrates 20, collectively, have a stack thickness 8. In certain embodiments, the stack thickness 8 can be as low as about 2 mm to an upper bound that depends on the upper limit of the thickness 18 of the carrier 10, e.g., about 100 mm stack thickness. In certain implementations, the stack thickness 8 of the article for coating 100 ranges from about 2 mm to about 30 mm, and all values between these limits.

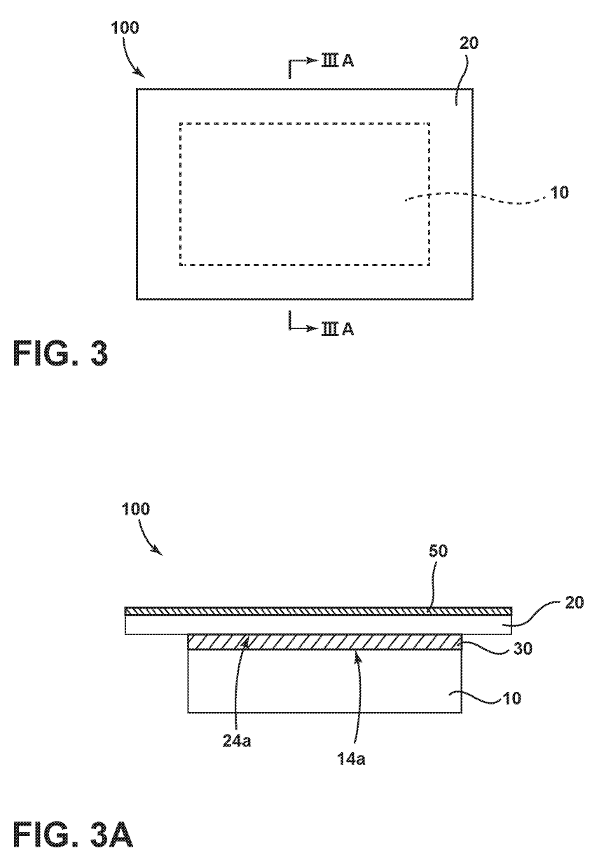

In certain embodiments, a higher lower bound for the adhesion energy (e.g., >150 mJ/m²) between the carrier surface modification layer 30 and the substrate bonding surface 24a may be desirable when the surface area of the carrier surface modification layer 30 is less than 100% (e.g., from about 60% to 100%) of the surface area of the substrate bonding surface 24a (see also FIGS. 3 and 3A, article for coating 100). As such, increased adhesion energies between the carrier 10 and the substrates 20 can be employed to offset a reduced contact area percentage between the carrier surface modification layer 30 and the substrates 20. For example, in one exemplary implementation of the article for coating 100, the surface area of the carrier surface modification layer 30 is about 60% to about 80% of the surface area of the substrate bonding surface 24a, and the adhesion energy that exists between the carrier surface modification layer 30 and the substrate bonding surface 24a is from 180 to 1000 mJ/m². Further, these adhesion energies can exist within the article 100 after a coating 50 is disposed on the substrates 20 at a coating temperature of 300° C. or less at a coating pressure from 10⁻⁶ Torr to 760 Torr.

Referring again to FIGS. 1 and 1A, the carrier 10 of the article for coating 100 may be of any suitable material including glass, for example. The carrier 10 need not be glass, but instead can be ceramic, glass-ceramic or metal (as the adhesion energy may be controlled in a manner similar to the processes and concepts outlined in this disclosure in exemplary fashion). If made of glass, carrier 10 may be of any suitable composition including alumino-silicate, boro-silicate, alumino-boro-silicate, soda-lime-silicate, and may be either alkali-containing or alkali-free depending upon its ultimate application.

Referring again to FIGS. 1 and 1A, the substrate 20 of the article for coating 100 may be of any suitable material according to the application for the substrate (e.g., cover glass for a mobile phone device) including glass, ceramic, or glass-ceramic, for example. When made of glass, the substrate 20 may be of any suitable composition, including alumino-silicate, boro-silicate, alumino-boro-silicate, soda-lime-silicate, and may be either alkali-containing or alkali-free depending upon its ultimate application. In certain embodiments, the compositions of the substrate 20 and the carrier 10 are selected such that their respective coefficients of thermal expansion (CTE) are similar to prevent warping, delamination, and other failures of the article for coating 100 during processing at elevated temperatures associated with CTE mismatch-induced thermal stresses. In preferred embodiments, the article for coating 100 includes a carrier 10 and one or more substrates 20 having a glass composition.

Still referring to FIGS. 1 and 1A, the surface modification layer 30 of the article for coating 100 can comprise any number of materials, selected to control the adhesion energy between the substrates 20 and the carrier 10. In certain embodiments, the surface modification layer 30 is a plasma-polymerized film from any number of hydrocarbon source gases, for example alkanes (including methane, ethane, propane, butane), alkenes (including ethylene, propylene), alkynes (including acetylene), and aromatics (including benzene, toluene), hydrogen and other gas sources. Plasma-polymerization creates a layer of highly cross-linked material. Control of reaction conditions and source gases can be used to control the film thickness, density, and chemistry to tailor the functional groups of the surface modification layer 30 for particular adhesion energies between the substrates 20 and the carrier 10. In exemplary embodiments, the surface modification layer 30 is a plasma-polymerized film that comprises a hydrocarbon-based material. In some embodiments of the article for coating 100, the hydrocarbon-based material is derived from a source gas comprising C₂H₄-H₂, N₂ and O₂ or CH₄, H₂N₂ and O₂.

Referring again to the article for coating 100 depicted in FIGS. 1 and 1A, the surface modification layer 30 has a thickness 38. In some embodiments, the thickness 38 ranges from about 0.1 nm to about 100 nm, from about 0.5 nm to about 50 nm, from about 1 nm to about 10 nm, or, more preferably, from about 1.5 nm to about 3 nm. For example, the thickness 38 can be 0.1 nm, 0.2 nm, 0.3 nm, 0.4 nm, 0.5 nm, 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm and all values between these thicknesses. In some preferred embodiments, the surface modification layer 30 includes a hydrocarbon-based material with a thickness 38 of about 2 nm.

Still referring to the article for coating 100 depicted in FIGS. 1 and 1A, the carrier bonding surface 14a is essentially integral with the upper primary surface 14 of the carrier 10 in certain embodiments. For example, the carrier bonding surface 14a can be developed from the upper primary surface 14 by treating the surface 14 with a cleaning process. In some embodiments, a cleaning process can be employed for this purpose in which the carrier 10 is cleaned in a dilute hydrogen peroxide and base (e.g., a standard clean 1 (SC1) as is known in the art) or a dilute hydrogen peroxide and deionized water solution at a temperature from ambient temperature to about 70° C. Cleaning removes particles from the bonding surfaces of the carrier 10 and allows for the development of a base-line surface energy for the carrier bonding surface 14a. With a stable surface energy associated with the cleaned, carrier bonding surface 14a, it is easier to control the adhesion energy between the substrate(s) 20 and the carrier 10 through the subsequent development of the carrier surface modification layer 30 over the bonding surface 14a.

According to other embodiments of the article for coating 100, the carrier surface modification layer 30 can have a smaller surface area than the primary surface of the carrier 14 and/or carrier bonding surface 14a. In such a configuration, manufacturing costs can be saved by limiting the extent of the surface modification layer 30 on the carrier 10 to conform to the relative size of the substrate(s) 20 temporarily bonded to the carrier. That is, the processes used to develop the surface modification layer 30 can be tailored to selectively deposit the surface modification layer 30 in particular regions of the carrier 10 that correspond to the temporary bonding location(s) of the substrate(s) 20. Besides reducing the material costs associated with the layer 30, the selective deposition of the surface modification layer 30 in this configuration can advantageously reduce the risk of residual amounts of surface modification layer 30 being left on the carrier 10 and/or substrate(s) 20.

According to some embodiments of the article for coating 100, the substrate(s) 20 are fabricated from a glass composition and subjected to a strength-enhancing process, e.g., for a display glass application. In certain embodiments, the strengthening can be achieved by thermal treatment, for example thermal tempering. In some embodiments, the strengthening can be achieved by thermally treating a substrate having a core portion and a clad portion. In some embodiments of a strength-enhanced substrate 20, one or more compressive stress regions are developed within the substrate that extend from a primary surface or surfaces to a selected depth or depths. In other embodiments, these compressive stress regions are developed through an ion-exchange (IOX) process. In such substrates with compressive stress regions developed through an IOX process, the compressive stress region(s) can include a plurality of ion-exchangeable metal ions and a plurality of ion-exchanged metal ions, the ion-exchanged metal ions selected so as to produce compressive stress in the compressive stress region(s) within the substrate 20. In certain embodiments of the article for coating 100, compressive stress regions are developed with the substrates with a maximum compressive stress (typically at the primary surface(s)) that can range from 50 MPa to 2000 MPa.

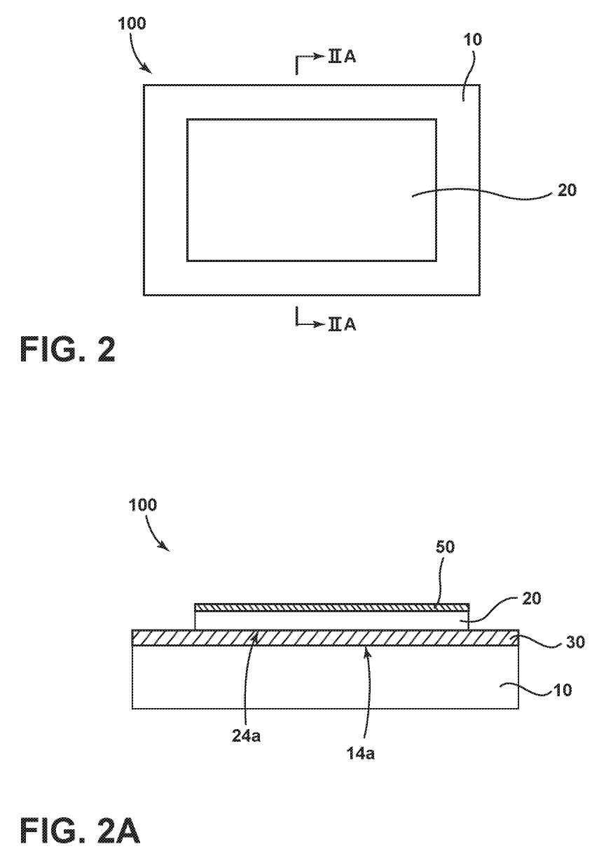

As shown in FIGS. 2 and 2A, some embodiments of the article for coating 100 includes a carrier 10, a substrate 20, and a carrier surface modification layer 30 and carrier bonding surface 14a disposed between the substrate 20 and the carrier 10. In certain implementations, this configuration of the article for coating 100 includes a carrier 10 that is sized for a single substrate 20 or a small number of substrates 20, for example, for substrates 20 of a relatively large size (e.g., Gen 5 or greater). In other embodiments of the article for coating 100 depicted in FIGS. 2 and 2A, a carrier 10 comprising a glass, glass-ceramic or ceramic material is sized to accommodate one substrate 20 to increase the reliability and/or manufacturing flexibility of the article 100. With regard to reliability, an article for coating 100 having a carrier 10 and a single substrate 20 can be arranged to minimize the size and non-bonded space of the carrier 10 to reduce the prevalence of potential strength-limiting defects and thus increase its strength. With regard to manufacturing flexibility, such an article for coating 100 with a relatively small-sized carrier 10 can be employed in a multitude of processes for developing the coating 50 on the substrate 20. That is, such an article 100 will present less dimensional-related constraints associated with coating apparatus and fixtures.

Referring now to FIGS. 3 and 3A, some embodiments of the article for coating 100 includes a carrier 10, a substrate 20, and a carrier surface modification layer 30 and carrier bonding surface 14a disposed between the substrate 20 and the carrier 10. In this configuration, more particularly, the article for coating 100 includes a surface modification layer 30 that has a smaller surface area than the substrate bonding surface 24a. In certain embodiments of the article for coating 100 depicted in FIGS. 3 and 3A, a higher lower bound for the adhesion energy (e.g., >150 mJ/m²) between the carrier surface modification layer 30 and the substrate bonding surface 24a may be desirable when the surface area of the carrier surface modification layer 30 is less than the surface area of the substrate bonding surface 24a. As such, increased adhesion energies between the carrier 10 and the substrates 20 can be employed to offset a reduced contact area percentage between the carrier surface modification layer 30 and the substrate 20. For example, in one exemplary implementation of the article for coating 100 shown in FIGS. 3 and 3A, the surface area of the carrier surface modification layer 30 is about 60% to about 80% of the surface area of the substrate bonding surface 24a, and the adhesion energy that exists between the carrier surface modification layer 30 and the substrate bonding surface 24a is from 180 to 1000 mJ/m². Further, these adhesion levels can exist within the article 100 after a coating 50 is disposed on the substrate 20 at a coating temperature of 300° C. or less at a coating pressure from 10⁻⁶ Torr to 760 Torr.

Advantageously, this configuration of the article for coating 100 depicted in FIGS. 3 and 3A minimizes the extent of the surface modification layer 30 in contact with the substrate 20, thus reducing the amount of the modification layer 30 that could potentially remain as unwanted residue after removal of the carrier 10 from the substrate 20 upon completion of developing the coating 50 on the substrate 20. Another benefit of this configuration is that a stable process for creating a surface modification layer 30 with a relatively constant adhesion energy can be developed while the extent of contact between the surface modification layer 30 and the substrate bonding surface 24a can be adjusted to obtain the proper balance of substrate 20 retention during coating while facilitating ease of removal of the substrate 20 upon completion of the coating process. A further benefit of this configuration of the article for coating 100 is that it facilitates edge coating of the substrates 20, which may be desired in certain applications of the substrate 20. In particular, this configuration of the article for coating 100 ensures that the surface modification layer 30 is spaced some distance from the edges of the substrate 20, thus allowing the edges of the substrate 20, along with its upper primary surface, to be coated with the coating 50.

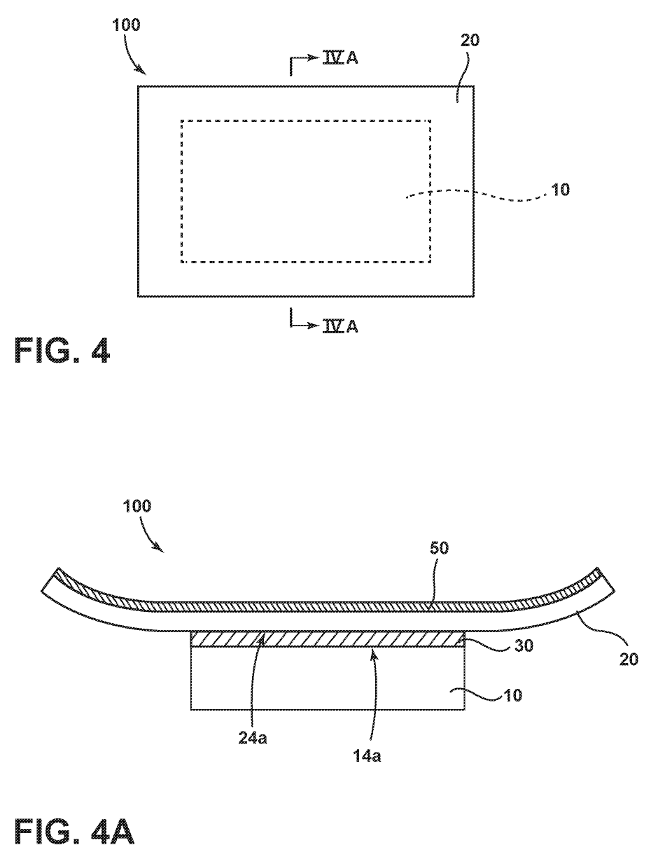

Referring now to FIGS. 4 and 4A, an article for coating 100 that includes a carrier 10, a substrate 20 having a substantially non-planar shape, and a carrier surface modification layer 30 and carrier bonding surface 14a disposed between the substrate 20 and the carrier 10 is depicted according to some embodiments of the disclosure. As shown in exemplary form in FIGS. 4 and 4A, the article for coating 100 includes a surface modification layer 30 that has a smaller surface area than the substrate bonding surface 24a. More particularly, the substrate 20 is substantially non-planar in shape and the substrate bonding surface 24a is located on a substantially planar portion of the substrate 20. Further, the carrier surface modification layer 30 is employed to join the carrier 10 to the planar portion of the substrate 20, at its substrate bonding surface 14a. The article for coating 100, with these particular features shown in FIGS. 4 and 4A, advantageously facilitates the coating of substantially non-planar substrates 20 by virtue of its design in temporarily bonding the surface modification layer 30 to the substrate 20 at a substantially planar region to the carrier 10.

In other implementations of the article for coating 100 depicted in FIGS. 4 and 4A, the substrate 20 may be substantially non-planar in shape and not possess any substantially planar regions. The surface modification layer 30 can still be temporarily bonded to the carrier 10 and substrate 20 in this configuration of the article for coating 100. For example, a significantly thicker surface modification layer 30 (e.g., that ranges from 100 nm to 10 microns) can be developed on the carrier 10 to accommodate the non-planar aspect of the substrate 20 given the typically greater compliance of the surface modification layer 30 relative to the substrate 20 and carrier 10 materials, particularly as the thickness of the surface modification layer is increased. In other embodiments, this configuration of the article for coating 100 can also employ non-planar features in the carrier 10, particularly at the carrier bonding surface 14a, to match the non-planar features of the substrate 20.

According to other embodiments of the disclosure, a method of preparing an article for coating (e.g., an article of coating 100 shown in FIGS. 1 and 1A) is provided. The method includes: treating a primary surface of a carrier (e.g., primary surface 14 of a carrier 10) to form a carrier bonding surface (e.g., carrier bonding surface 14a), the carrier having a thickness of at least 2 mm (e.g., thickness 18 of the carrier 10). The method also includes: disposing a carrier surface modification layer (e.g., surface modification layer 30) on the carrier bonding surface; and bonding the carrier to at least one substrate (e.g., substrate 20) having a substrate bonding surface (e.g., substrate bonding surface 24a) and a thickness from about 0.1 mm to about 3.5 mm (e.g., thickness 28 of the substrate 20), the bonding conducted by temporarily joining the carrier at the carrier surface modification layer to the substrate at the substrate bonding surface. Further, the treating and disposing steps are conducted such that an adhesion energy between the carrier surface modification layer and the substrate bonding surface is from 50 to 1000 mJ/m² after the bonding step.

With further regard to the method of preparing an article for coating, the step of treating a primary surface of the carrier (e.g., carrier 10) can include a cleaning process. Cleaning removes particles from the bonding surface of the carrier and allows for the development of a base-line surface energy for the carrier bonding surface. With a stable surface energy associated with the cleaned, carrier bonding surface (e.g., carrier bonding surface 14a), it is easier to control the adhesion energy between the substrate(s) and the carrier through the subsequent development of the carrier surface modification layer over the bonding surface. In some embodiments of the method, the treating step is conducted with a dilute hydrogen peroxide and base (e.g., an SC1 process) or a dilute hydrogen peroxide and deionized water solution at a temperature from ambient temperature to about 70° C. In the former approach, deionized water and hydrogen peroxide can be prepared at a ratio of 40:2, with the cleaning conducted with this solution at about 55° C. It should also be understood that the same steps employed in the method for treating the carrier can also be employed to treat the surfaces of the substrates to be coated and/or temporarily bonded to the carrier. Further, those with ordinary skill in the art will also understand that various permutations to the treating step can be made, including the use of deionized water alone, brushes, ultrasonic cleaning devices, and other devices for cleaning the surface of the carrier prior to development of a surface modification layer.

Referring again to the method of preparing an article for coating, the step of disposing the carrier surface modification layer (e.g., surface modification layer 30) can be conducted with various methods to produce a layer that results in an adhesion energy that ranges from about 50 mJ/m² to about 1000 mJ/m² between the carrier and the substrate(s). For example, a surface modification layer comprising a hydrocarbon-based material can be developed on the carrier using an inductively coupled plasma (ICP) process that employs a precursor gas comprising a mixture of C₂H₄-H₂ and N₂-O₂ gases. As another example, a surface modification layer comprising a hydrocarbon-based material can be developed on the carrier using a reactive ion etching (RIE) process that employs a precursor gas comprising a mixture of CH₄, H₂N₂ and O₂ gases. In certain implementations of the method, the step of disposing the coating onto the substrate 20 is conducted at a temperature of less than 300° C. at a pressure from 10⁻⁶ Torr (1.32×10⁻⁹ atm) to 760 Torr (1 atm). In the foregoing RIE and ICP approaches, the surface modification layer can be developed on the carrier at an ambient temperature. Further, in preferred implementations of the method, the surface modification layer is developed on the carrier and includes an adhesion energy that ranges from about 50 mJ/m² to 1000 mJ/m² between the carrier surface modification layer and the substrate(s) and remains stable while the article comprising the carrier and substrate(s) is subjected to additional process steps for coating the substrate(s) at temperatures up to 300° C.

Still referring to the method of preparing an article for coating, the step of bonding the carrier to at least one substrate (e.g., substrate 20 as shown in FIGS. 1, 1A) can be conducted by temporarily joining the carrier at the carrier surface modification layer to the substrate at the substrate bonding surface. As understood by those with ordinary skill in the field, various approaches can be employed to effect this step—e.g., manually joining the carrier with its surface modification layer to the bonding surface of the substrate(s), pressing these features together in an isostatic press, by pressing rollers, etc. Further, the bonding step is conducted in a fashion to ensure that the adhesion energy between the carrier surface modification layer and the substrate bonding surface is from 50 to 1000 mJ/m² and will remain in this range during and after any steps to coat the substrate with a functional coating (e.g., coating 50 as shown in FIGS. 1, 1A).

The method of preparing an article for coating can also include a step of coating the substrate(s) with a functional coating (e.g., coating 50 as shown in FIGS. 1, 1A). The coating, for example, can be a scratch-resistant layer deposited on at least one primary surface of the at least one substrate with a physical vapor deposition or plasma-enhanced vapor deposition process. Further, the process employed to develop the coating on the substrate(s) can be conducted from ambient temperature up to about 300° C., depending on the particular coating process employed. In certain embodiments, the coating is disposed on the at least one substrate with a drum coating process that subjects the at least one substrate to a centrifugal force from about 1 N to 20 N. Accordingly, the adhesion energy between the carrier surface modification layer and the substrate bonding surface should remain from 50 to 1000 mJ/m² after such a drum coating process is employed.

Referring again to the method of preparing an article for coating, the method can also include a step of de-bonding the carrier from the at least one substrate after the coating is disposed on the at least one substrate, the de-bonding conducted by mechanically separating the carrier surface modification layer from the substrate bonding surface without breakage to the carrier and the substrate. In certain embodiments, the de-bonding is conducted with a manual operation to physically remove or peel the carrier from the substrate(s) or vice versa. In other embodiments, mechanical fixtures can be employed to grip the carrier and a manual operation can be conducted to de-bond the substrate(s) from the carrier. In further embodiments, mechanical fixtures can be employed to grip both the carrier and the substrate(s), and these fixtures can be controlled to de-bond the carrier from the substrate(s) or vice versa. Preferably, the de-bonding (and prior steps of the method) is conducted such that the substrate bonding surface has no more than trace amounts of the carrier surface modification layer after the de-bonding. Accordingly, in certain embodiments the adhesion energy between the carrier surface modification layer and the carrier is higher than the adhesion energy between the carrier surface modification layer and the substrate bonding surface, all within the range of from 50 to 1000 mJ/m². The step of treating the carrier in the method can be adjusted, in some implementations, for this purpose of achieving a desired adhesion energy.

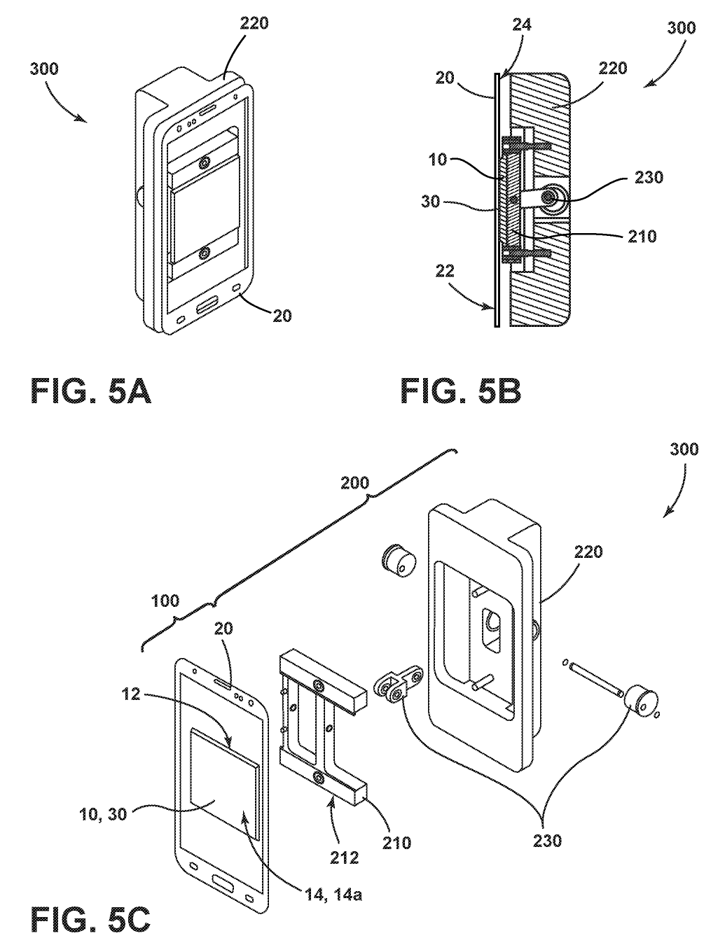

Turning now to FIGS. 5A-5C, a fixture assembly 300 for coating a substrate 20 or an article for coating 100 is provided according some embodiments of the disclosure. The fixture assembly 300 includes: at least one carrier 10 having a carrier bonding surface 14a, a mounting surface (e.g., lower primary surface 12) and a thickness of at least 2 mm. Further, the fixture assembly 300 includes a carrier surface modification layer 30 disposed on the carrier bonding surface 14a; and a cam assembly 200. The cam assembly 200 includes at least one clamp 210 with a clamp surface 212 that is removably coupled to the mounting surface of the at least one carrier 10, and a plate 220 that is removably coupled to the at least one clamp 210 via a cam assembly 230. Further, the carrier surface modification layer 30 temporarily couples substrate bonding surface 24a (not shown) integrally with a lower primary surface 24 of a substrate 20 with an adhesion energy from 50 to 1000 mJ/m² between the carrier surface modification layer 30 and the substrate bonding surface 24a.

Referring again to FIGS. 5A-5C, the fixture assembly 300 positions and secures the substrate 20 or the article for coating 100 as part of an apparatus for coating the substrate 20 with a functional coating (e.g., coating 50 as shown in FIGS. 1, 1A). The clamp surface 212 is mechanically attached to the mounting surface (e.g., lower primary surface 12) of the carrier 10, which in turns temporarily holds the substrate 20 in place by virtue of its carrier surface modification layer 30. The clamp surface 212 is part of the clamp 210, which is removable attached to a plate 220 via the cam assembly 230. As such, the plate 220 can be attached to a mechanical fixture to position and move the article of coating 100 in an apparatus for coating the substrate 20 with a functional coating. Such an apparatus for employing the fixture assembly 300 can include a drum coater for drum coating the substrate 20 at a centrifugal force from about 1 N to about 20 N. Once the process for coating the substrate 20 with the coating has been completed, the article for coating 100 can be removed from the fixture assembly 300 at the clamp surface 212. Upon removal from the fixture assembly 300, the article for coating 100 can be subjected to a de-bonding step to mechanically separate the substrate 20, now possessing a functional coating, from the carrier 10.

Referring again to the fixture assembly 300 depicted in FIGS. 5A-5C, the carrier surface modification layer 30 temporarily couples or bonds to a substrate bonding surface 24a (see FIGS. 1, 1A) of the substrate 20 with an adhesion energy from 50 to 1000 mJ/m² between the carrier surface modification layer 30 and the substrate bonding surface 24a after the temporary coupling and the subsequent coating deposition. In some embodiments of the fixture assembly 300, the carrier surface modification layer 30 in the article for coating 100 temporarily couples a substrate bonding surface 24a of a substrate 20 that is substantially non-planar in shape (see FIGS. 4, 4A) such that an adhesion energy from 50 to 1000 mJ/m² exists between the carrier surface modification layer 30 and the substrate bonding surface 24a. Accordingly, in this configuration, the fixture assembly 300 can be used for coating operations for non-planar substrates 20.

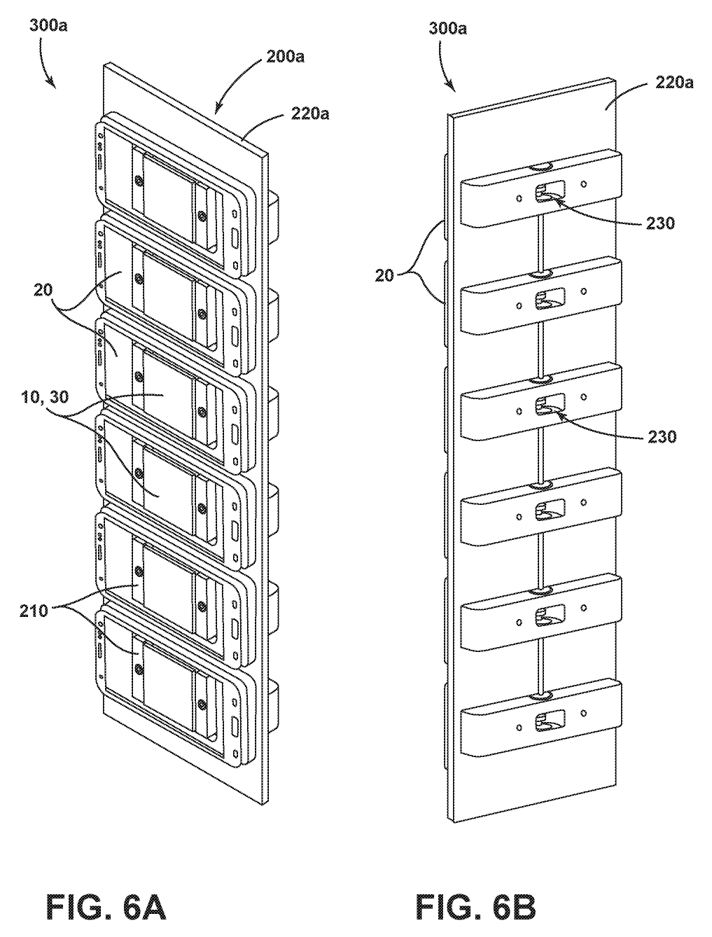

Referring now to FIGS. 6A and 6B, a fixture assembly 300a for coating a plurality of substrates 20 is provided according to some embodiments of the disclosure. The fixture assembly 300a is similar to the fixture assembly 300 depicted in FIGS. 5A-5C, and like-numbered elements have the same or similar function and structures. The primary difference between the two fixture assemblies is that the fixture assembly 300a can accommodate multiple substrates 20 on one cam assembly 200a. More particularly, cam assembly 200a includes a plate 220a having multiple clamps 210, each with its own clamp surface 212 that is removably coupled to the mounting surface of corresponding carriers 10. Further, the plate 220a is removably coupled to the clamps 210 via cam assemblies 230. As such, the cam assembly 200a can position and secure multiple carriers 10 and corresponding substrates 20 by virtue of having multiple clamps 210 to facilitate operations to coat the substrates 20 with a functional coating (e.g., coating 50 shown in FIGS. 1, 1A) in one coating step. Once the process for coating the substrates 20 with the coating has been completed, each article for coating 100 can be removed from the fixture assembly 300a at the clamp surface 212 (see FIGS. 5A-5C) of the clamps 210. Upon removal from the fixture assembly 300a, each article for coating 100 can be subjected to a de-bonding step to mechanically separate each substrate 20, now possessing a functional coating, from the carrier 10.

It should be emphasized that the above-described embodiments of the present disclosure, including any embodiments, are merely possible examples of implementations, merely set forth for a clear understanding of various principles of the disclosure. Many variations and modifications may be made to the above-described embodiments of the disclosure without departing substantially from the spirit and various principles of the disclosure. All such modifications and variations are intended to be included herein within the scope of this disclosure and protected by the following claims.

The terms “substantial,” “substantially,” and variations thereof as used herein are intended to note that a described feature is equal or approximately equal to a value or description. For example, a “substantially planar” surface is intended to denote a surface that is planar or approximately planar.

1. A method of preparing an article for coating, comprising:
treating a primary surface of a carrier to form a carrier bonding surface;
disposing a carrier surface modification layer on the carrier bonding surface;
bonding the carrier to at least one substrate, the at least one substrate comprising a substrate bonding surface, the bonding conducted by temporarily joining the carrier at the carrier surface modification layer to the at least one substrate at the substrate bonding surface of the at least one substrate,
wherein the treating and disposing steps are conducted such that an adhesion energy between the carrier surface modification layer and each of the substrate bonding surfaces is from 50 to 1000 mJ/m² after the bonding step.

2. The method according to claim 1, the carrier comprising a thickness of at least 2 mm, and the at least one substrate comprising a thickness from about 0.1 mm to about 3.5 mm.

3. The method according to claim 1, wherein the adhesion energy is from 50 to 1000 mJ/m² after a coating is disposed on the at least one substrate at a coating temperature of 300° C. or less and a coating pressure from 10⁻⁶ Torr to 760 Torr.

4. The method according to claim 1, wherein the surface area of the carrier surface modification layer is about 60% of the surface area of the substrate bonding surfaces, and the adhesion energy is from 180 to 1000 mJ/m² after the bonding step.

5. The method according to claim 3, wherein the at least one substrate is a strengthened substrate suitable for display glass applications.

6. The method according to claim 3, wherein the coating is a scratch-resistant layer deposited on at least one primary surface of the at least one substrate with a physical vapor deposition or plasma-enhanced vapor deposition process.

7. The method according to claim 3, wherein the coating is disposed on the at least one substrate with a drum coating process that subjects the at least one substrate to a centrifugal force from about 1 N to 20 N.

8. The method according to claim 3, wherein the treating step comprises cleaning the primary surface of the carrier with a cleaning composition comprising deionized water and hydrogen peroxide at a temperature from ambient temperature to 70° C.

9. The method according to claim 3, wherein the carrier surface modification layer comprises a hydrocarbon-based material.

10. The method according to claim 3, further comprising the step:
de-bonding the carrier from the at least one substrate after the coating is disposed on the at least one substrate, the de-bonding conducted by mechanically separating the carrier surface modification layer from the substrate bonding surface of the at least one substrate without breakage to the carrier and the at least one substrate.

11. The method according to claim 10, wherein the substrate bonding surface of the at least one substrate comprises no more than trace amounts of the carrier surface modification layer after the de-bonding step.

12. The method according to claim 1, wherein the at least one substrate is substantially non-planar in shape.

13. The method according to claim 1, wherein the at least one substrate is substantially non-planar in shape and the substrate bonding surface of the at least one substrate is located on a substantially planar portion of the at least one substrate.

14. The method according to claim 1, wherein the carrier surface modification layer has a smaller surface area than the primary surface of the carrier.

15. The method according to claim 1, wherein the surface modification layer has a smaller surface area than the substrate bonding surface of the at least one substrate.

16. An article for coating, comprising:
a carrier comprising a carrier bonding surface;
a carrier surface modification layer disposed on the carrier bonding surface; and
at least one substrate, the at least one substrate comprising a substrate bonding surface,
wherein the carrier surface modification layer and the substrate bonding surface of the at least one substrate are joined such that such that an adhesion energy from 50 to 1000 mJ/m² exists between the carrier surface modification layer and the substrate bonding surface of the at least one substrate, and
further wherein the carrier is mechanically removable from the at least one substrate without breakage to the at least one substrate and the carrier.

17. The article according to claim 16, the carrier comprising a thickness of at least 2 mm, the at least one substrate comprising a thickness from about 0.1 mm to about 3.5 mm.

18. The article according to claim 16, wherein the adhesion energy is from 50 to 1000 mJ/m² after a coating is disposed on the at least one substrate at a coating temperature of 300° C. or less and a coating pressure from 10⁻⁶ Torr to 760 Torr.

19. The article according to claim 16, wherein the surface area of the carrier surface modification layer is about 60% of the surface area of the substrate bonding surface of the at least one substrate, and the adhesion energy is from 180 to 1000 mJ/m² after a coating is disposed on the at least one substrate at a coating temperature of 300° C. or less and a coating pressure from 10⁻⁶ Torr to 760 Torr.

20. The article according to claim 16, wherein the carrier surface modification layer comprises a hydrocarbon-based material.

21. The article according to claim 16, wherein the carrier is mechanically removable from the at least one substrate such that the substrate bonding surface of the at least one substrate comprises no more than trace amounts of the carrier surface modification layer.

22. A fixture assembly for coating a substrate, comprising
at least one carrier comprising a carrier bonding surface, and a mounting surface;
a carrier surface modification layer disposed on the carrier bonding surface; and
a cam assembly comprising at least one clamp that is removably coupled to the mounting surface of the at least one carrier, and a plate removably coupled to the at least one clamp,
wherein the carrier surface modification layer temporarily couples to a substrate bonding surface of a substrate with an adhesion energy from 50 to 1000 mJ/m².

23. The fixture assembly according to claim 22, wherein the at least one carrier and the at least one clamp are a plurality of corresponding carriers and clamps, and further wherein the carrier surface modification layer of each carrier temporarily couples to a substrate bonding surface of a substrate with an adhesion energy from 50 to 1000 mJ/m².

24. The fixture assembly according to claim 22, wherein the carrier surface modification layer temporarily couples to a substrate bonding surface of a substrate with an adhesion energy from 50 to 1000 mJ/m² after the coupling and the deposition.

25. The fixture assembly according to claim 22, wherein the fixture is adapted for coating a plurality of substrates in a drum coating process that subjects each substrate to a centrifugal force from about 1 N to 20 N.

26. The fixture assembly according to claim 22, wherein the carrier surface modification layer temporarily couples with a substrate bonding surface of a substrate that is substantially non-planar in shape such that an adhesion energy from 50 to 1000 mJ/m² exists between the carrier surface modification layer and the substrate bonding surface.

27. The fixture assembly according to claim 22, the at least one carrier comprising a thickness of at least 2 mm.

28. The article according to claim 16, wherein the at least one substrate comprises a plurality of substrates.

29. The method according to claim 1, wherein the at least one substrate comprises a plurality of substrates.
